(19) United States
(12) Patent Application Publication
(10) Pub. No.: US 2016/0071101 A1
(43) Pub. Date: Mar. 10, 2016

(54) SELFIE FINANCIAL SECURITY TRANSACTION SYSTEM

(71) Applicant: TYSON YORK WINARSKI, Mountain View, CA (US)

(72) Inventor: TYSON YORK WINARSKI, Mountain View, CA (US)

(21) Appl. No.: 14/634,774

(22) Filed: Feb. 28, 2015

Related U.S. Application Data
(60) Provisional application No. 62/091,742, filed on Dec. 15, 2014.
(60) Provisional application No. 62/047,663, filed on Sep. 9, 2014.

(51) Int. Cl. G06Q 20/38; G06K 9/00; G06Q 20/40

(52) U.S. Cl. CPC G06Q 20/3829; G06Q 20/409; G06Q 20/40145; G06K 9/00288; G06Q 2220/00

(57) ABSTRACT

A financial card activation and authorization system for a transaction is disclosed. An image of an account holder and his financial card is captured and used to develop an encryption key to secure the account information. Subsequent transactions are then authorized by sending an image of the purchaser's face and the financial card by comparing it to the original picture of the account holder who activated the card.

### SPECIFICATION

This application claims the benefit of U.S. Provisional Application No. 62/091,742, filed Dec. 15, 2014, which is hereby incorporated by reference, as well as U.S. Provisional Application 62/047,663 filed on Sep. 9, 2014, which is also hereby incorporated by reference.

### BACKGROUND

Security is essential for financial transactions and the financial system in general. A massive amount of financial transactions occur electronically over an Internet. Huge numbers of point-of-sales terminals communicate electronically with financial institutions that store account information in the cloud. The presence of such a massive volume of financial transactions and financial wealth in electronic form in the cloud over the Internet naturally arouses the interest of criminal elements. There is therefore a great need for new and improved technological security systems that are user friendly to protect electronic financial transactions from security breaches in the cloud over the Internet.

### SUMMARY

A financial card activation and authorization system for a transaction is disclosed. The financial card authorization system is configured to work with any card connected with a financial account, such as a credit card, a debit card, an electronic funds transfer card, a point-of-sale card, an electronic funds gift card, or any other card coupled to financial assets.

Financial transactions with the financial card are authorized utilizing an image containing both facial recognition features of a financial card account holder and a visual financial card identifier on a financial card belonging to the financial card account holder.

A transaction computer system is connected to a plurality of point-of-sale devices through a global computing network such as the Internet. These point-of-sale devices are any electronic device capable of connecting to the transaction computer system through the Internet. These point-of-sale devices also have the ability to capture an image at the point-of-sale location and transmit it to the transaction computer system. These point-of-sale devices also have software configured to conduct a financial transaction with the transaction computer system. The transaction computer system maintains a financial account for the financial account holder. The financial account is coupled to the financial card, also referred to as a financial transaction card. The transaction computer system includes a selfie-cryptographic key generator and a database.

The selfie-cryptographic key generator receives images from point-of-sale terminals that include both facial recognition features of a financial card account holder and a visual financial card identifier on a financial card belonging to the financial card account holder. The selfie-cryptographic generator generates a selfie-cryptographic key using both the facial recognition features and the visual financial card identifier from the image.

The database contains financial card account information for the financial card account holder encrypted with the selfie-cryptographic key. The financial card account information includes a financial card transaction authorization code. The financial card transaction authorization code enables the completion of a financial transaction between the financial card account holder and a merchant.

The transaction computer system transmits the financial card authorization code when the selfie-cryptographic key successfully decrypts the financial card account information. During this process, the transaction computer system does not permanently store the selfie-cryptographic key but retains it for a transitory period during authorization of the financial card transaction. The transitory period ends upon completion of the transaction. Alternatively, the transitory period ends upon transmission of authorization to a point-of-service terminal.

The selfie-cryptographic key generator utilizes transaction algorithms for computing facial recognition features and visual financial card identifiers and formulating them into the selfie-cryptographic key.

The selfie-cryptographic key is computed by the selfie-cryptographic key generator from a single image containing both the facial recognition features of the financial account holder and the visual financial card identifier. The single image is acquired by a digital camera at a point-of-service terminal during the financial card transaction. The transaction computer system does not store the single image but for a transitory period during authorization of the financial card transaction. The transitory period ends upon completion of the transaction. Alternatively, the transitory period ends upon transmission of authorization to a point-of-service terminal.

The visual financial card identifier is information printed on the financial card. The information printed on the financial card may include, but is not limited to a QPR code, a bar code, or a hologram. The financial card account information for the financial card account holder is initially encrypted with an initial cryptographic key that is not generated from facial recognition features of the financial card account holder. The financial card account information for the financial card account holder is re-encrypted with the selfie-cryptographic key during a financial card activation process in which the financial card account holder takes a single activation image of their face together with the visual financial card identifier on the financial card with an authorized device. The activation image is received by the selfie-cryptographic generator to create the selfie-cryptographic key from the authorized device.

The authorized device may be a mobile electronic device previously associated with the account information. The authorized device may also be a non-mobile wired device previously associated with the account information. The single activation image is not stored by the transaction computer system image but for a transitory period during activation of the financial card. The transitory period ends upon completion of said transaction. Alternatively, the transitory period ends upon transmission of authorization to a point-of-service terminal. A image analysis security module is provided to analyze the single image to ensure that it has not been altered or tampered with indicating a possibly forged single image. The selfie-cryptographic key generator generates a key from the single image only when the image analysis security module determined that the single image has not been tampered with. The transaction computer system does not permanently store the single image, but retains it for a transitory period during authorization of the financial card transaction.

A financial card authorization system for a transaction is disclosed that includes a database containing encrypted account information for a financial card account holder encrypted with a selfie-cryptographic key. The selfie-cryptographic key is generated utilizing first data contained within a first single image. The first data includes both facial recognition features of the financial card account holder and a visual card identifier on a financial card associated with the account information. The system also includes a cryptographic key generator that generates a transaction-cryptographic key utilizing second data contained within a second single image. The second data includes both the visual financial card identifier on the financial card and facial recognition features of a person in possession of the financial card. Additionally, the system also includes a transaction system that applies the transaction-cryptographic key to the encrypted account information stored in the database. The transaction system transmits a transaction authorization code when the transaction-cryptographic key successfully decrypts the encrypted account information. The financial card authorization system does not permanently store the transaction-cryptographic key but retains it for a transitory period during an authorization of a financial card transaction. The cryptographic key generator generates the selfie-cryptographic key. The financial card authorization system does not permanently store the selfie-cryptographic key but retains it for a transitory period during encryption of the account information in the database. The first single image is a first digital picture of the financial card placed next to the financial card account holder's face. The second single image is a second digital picture of the financial card placed next to the face of the person in possession of the financial card. The cryptographic key generator utilizes a facial recognition module to extract facial recognition features from the first digital picture of the financial card account holder's face. The cryptographic key generator utilizes the facial recognition module to extract facial recognition features from the second digital picture of the face of the person in possession of the financial card. The visual financial card identifier is information printed on the financial card. The information printed on the financial card is a QPR code, a bar code, or a hologram. The encrypted account information for the financial card account holder is initially encrypted with an initial-cryptographic key before it is encrypted with the selfie-cryptographic key. The initial-cryptographic key is generated without any facial recognition features of the financial card account holder. The encrypted account information for the financial card account holder is then re-encrypted with the selfie-cryptographic key during a financial card activation process in which the financial card account holder creates the first single image utilizing an authorized device that digitally transmits the first single image to the cryptographic key generator across a communications network. The authorized device is a mobile electronic device previously associated with the account information. The authorized device may also be a non-mobile wired electronic device previously associated with the account information.

The financial card authorization system may also include an image analysis security module. The cryptographic key generator generates the selfie-cryptographic key from the first single image only when it is authorized by the image analysis security module when the image analysis security module determines that the first single image has not been tampered with. The cryptographic key generator generates the transaction-cryptographic key from the second single image only when it is authorized by the image analysis security module when the image analysis security module determines that the second single image has not been tampered with. The transaction system transmits a transaction rejection code when the image analysis security module determines that the second single image has been tampered with. The transaction system transmits a transaction rejection code when the transaction-cryptographic key unsuccessfully decrypts the encrypted account information. The cryptographic key generator receives the second single image via a digital message sent over a communications network from a point-of-service terminal equipped with a digital camera. The digital camera captured the single second image. The financial card authorization system does not permanently store the first single image but retains it for a transitory period during encryption of the account information in the database. The financial card authorization system does not permanently store the second single image but retains it for a transitory period during the transaction.

Further aspects of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates financial transaction card that includes a visual financial card identifier;

FIG. 2 illustrates an authorized device taking a single image containing both the face of a financial card account holder and the visual financial card identifier of the financial transaction card;

FIG. 3 illustrates a block diagram of an authorized device coupled to a transaction computer system through a global computer network;

FIGS. 4-8 depict a process where a financial card account holder activates a financial card for use;

FIG. 4 illustrates a flow chart depicting a process whereby a financial card account holder takes a single digital image of both the account holder's face and the visual identifier on the financial card with an authorized device and transmits it to the transaction computer system;

FIG. 5 illustrates a flow chart depicting a process whereby a selfie-image security module performs a security scan on the single digital image;

FIG. 6 illustrates a portion of the single digital image showing the facial recognition features of the financial card account holder;

FIG. 7 depicts the operation of the selfie-cryptography key generator as it combines facial recognition data and financial card visual identifier data into a combined single set of data with various algorithms;

FIG. 8 illustrates a flow chart depicting a process for generating a selfie-cryptographic key from the single image and using it to encrypt a financial card transaction authorization code;

FIG. 9 depicts a database table stored in a database containing information of the financial card account holder including the encrypted and unencrypted financial card transaction authorization codes;

FIG. 10 illustrates a block diagram of several POS terminals coupled to a transaction computer system through a global computer network;

FIG. 11 illustrates a block diagram of a POS terminal including a digital camera and a communications module;

FIG. 12-15 illustrates a process whereby a financial card account holder makes a transaction at a POS terminal with a financial transaction card;

FIG. 12 illustrates a flowchart depicting a process whereby a POS terminal takes a single digital image containing both facial recognition data of a financial card account holder and a visual identifier of a financial transaction card;

FIG. 13 illustrates a flowchart depicting a process whereby selfie-image security module performs a security scan of the single digital image;

FIG. 14 illustrates a flowchart depicting a process where a selfie-cryptographic key generator creates a selfie-cryptographic key by extracting facial recognition data and other data from the visual identifier of the financial transaction card;

FIG. 15 illustrates a flowchart depicting a process where the decrypted and unencrypted financial card transaction authorization codes are compared to determine whether to authorize the transaction;

FIG. 16 illustrates a flow chart depicting a process for retention of the single digital image by the transaction computer system; and

FIG. 17 illustrates a flow chart depicting a process for retention of the single digital image by the transaction computer system.

### DETAILED DESCRIPTION

While the invention has been shown and described with reference to a particular embodiment thereof, it will be understood to those skilled in the art, that various changes in form and details may be made therein without departing from the spirit and scope of the invention.

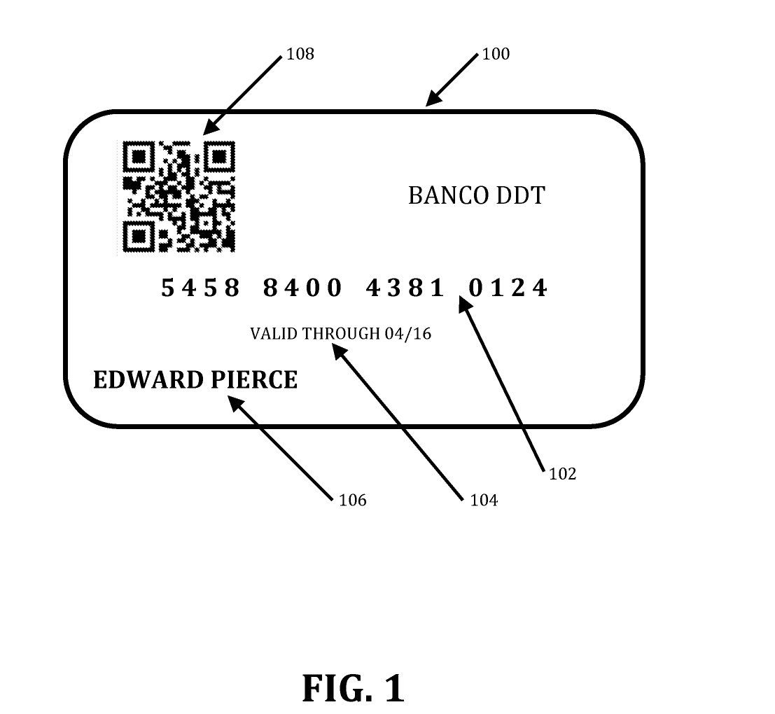

FIG. 1 illustrates financial transaction card 100 that includes a visual financial card identifier 108. Financial transaction card 100 includes an account number 102, which in this example is a 16-digit number. Card 100 also includes a date 104 through which the card is valid. Financial transaction card 100 may also be referred to as a financial card or a card. Financial transaction card 100 includes printing showing that the account holder is Edward Pierce 106. Financial transaction card 100 is issued by the exemplary financial institution BANCO DDT. Financial transaction card 100 may be, for example, a credit card, a debit card, an electronic funds transfer card, a point-of-sale card, an electronic funds gift card, or any other card coupled to financial assets.

Financial transaction card 100 includes a visual identifier 108. Visual identifier 108 is in this example a QR code. The use of a QR code is merely exemplary. Any visual information on financial transaction card 100 that allows for the visual identification of the account held by the account holder Edward Pierce 106 functions as visual identifier 108. Account number 102 could function as a visual identifier 108. The object of visual identifier 108 is to allow a digital camera to take an image of card 100 so that a computer can identify the account 102 purely from the digital image without taking any information from the magnetic stripe of card 100 through a card swipe or from manual data entry. Bar codes, holograms, or any other visual identifier that can specifically identify account number 102 through a digital image can function as visual identifier 108.

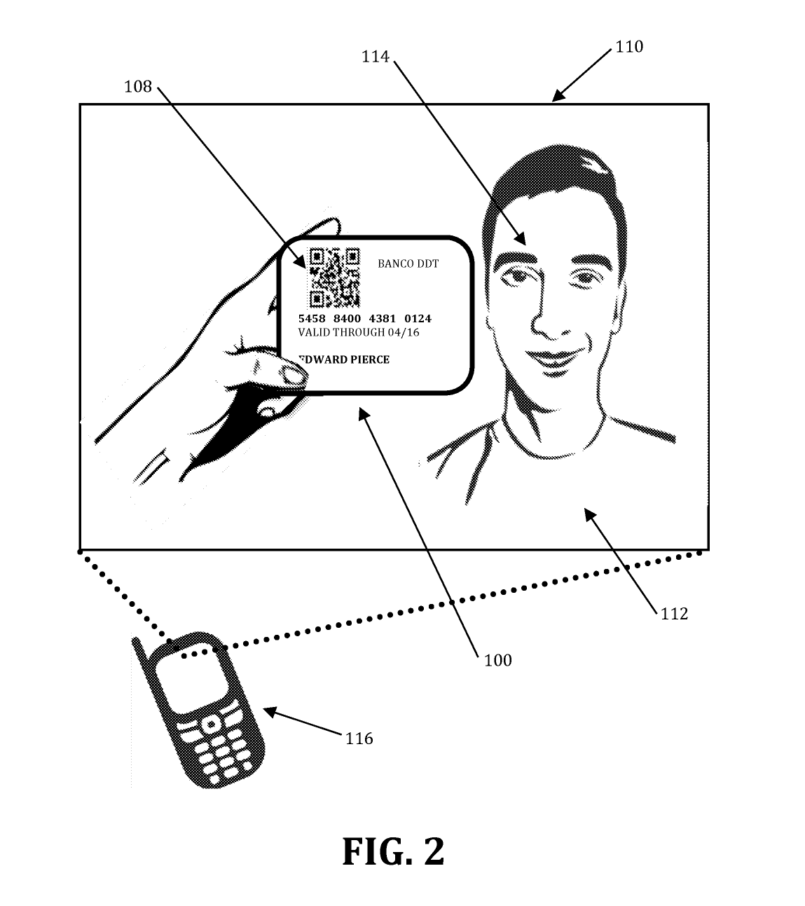

FIG. 2 illustrates an authorized device 116 taking a single image 110 containing both the face 114 of a financial card account holder 112 and the visual financial card identifier 108 of the financial transaction card 100. When financial card account holder 112 receives a new financial card 100, account holder 112 must first activate card 100. In this system, the account holder 112, identified as Edward Pierce 106, takes a selfie-photograph 100 with the digital camera on his cell phone 116. The selfie-photograph 100 is a single digital image 100. The single digital image 100 includes both the face 114 of account holder 112 and visual identifier 108. As single digital image 100 contains an image of visual identifier 108, the account 102 of account holder 112 can be identified through single digital image 100. In addition, as single digital image 100 contains an image of face 114 of account holder 112, biometric facial recognition data can be extracted identifying the identity of account holder 112. Further, as single digital image 110 includes both visual identifier 108 and facial recognition data 114 of account holder 112, single digital image 110 shows that card 100 is in the possession of account holder 112. Registered device 116 will encrypt single digital image 110. Registered device 116 will then transmit the encrypted single digital image 110 to complete the process to activate card 100 via a digital message.

It is contemplated that financial institutions maintain a listing of authorized or registered devices for account holders 112. This listing of authorized or registered devices may include an account holder's cell phone 116, personal home computer, personal tablet, work computer, or any other mobile or wired device that the account holder regularly uses. These authorized or registered devices may be identified through an electronic identifier such as a cell phone number, a mac address, an IP address, or other electronic identifier. Typically, account holder 112 will self-identify these regularly used devices with the financial institution through a mutual authentication process.

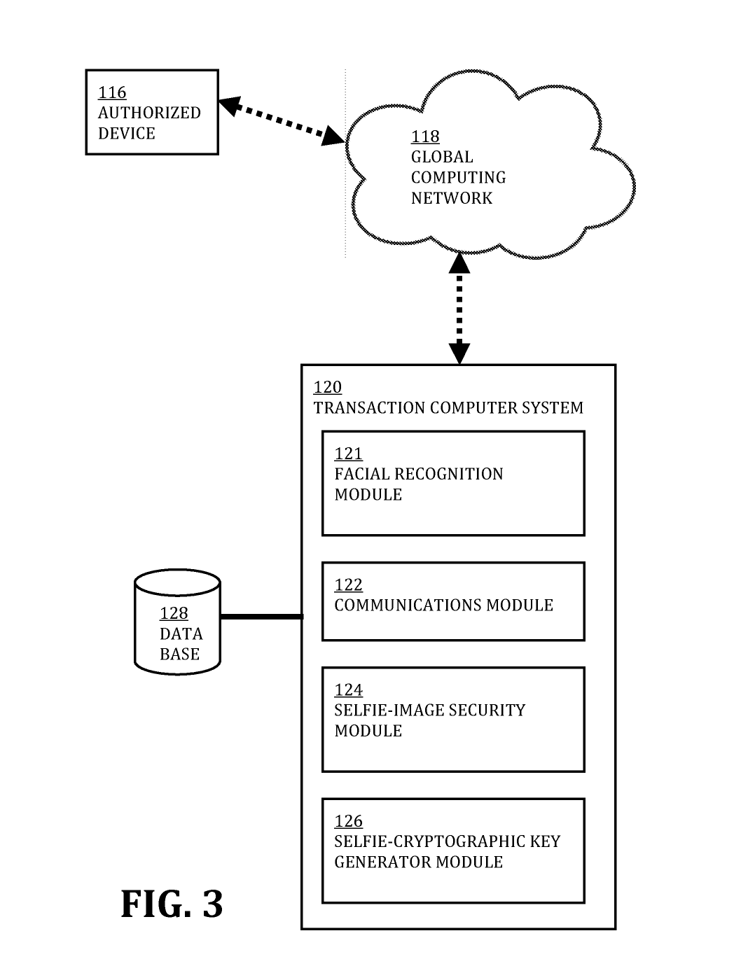

FIG. 3 illustrates a block diagram of an authorized device 116 coupled to a transaction computer system 120 through a global computer network 118. Registered device 116, also referred to as an authorized device 116, is in bi-directional communications with transaction computer system 120 through global computing network 118. Similarly, transaction computer system 120 is in bidirectional communications with registered device 116 through global computing network 118.

Transaction computer system 120 is a computing system that maintains and manages the financial account 102 of account holder 112. Transaction computing system 120 is typically maintained by a financial institution, such as a bank, credit union, savings and loan, or other financial entity. Transaction computing system 120 includes a communications module 122. Communications module sends and receives transmissions from registered device 116 through global computing network 118. Communications module 122 has the ability to encrypt and decrypt messages.

Card 100 is initially sent to account holder 112 not activated. In order to active card 100, account holder 112 takes a single digital image 110 with authorized device 116 of both his face 114 and visual identifier 108. Authorized device 116 encrypts single digital image 110 and transmits it to transaction computer system 120 through global computing network 118 via a digital message. The encrypted single digital image 110 is received by communications module 122 where it is decrypted.

After decrypting single digital image 110, communications module 122 sends single digital image 110 to selfie-image security module 124. Selfie-image security module 124 is a digital image analysis security system that performs an analysis of single digital image 110 to determine whether single digital image 110 has been tampered with. A criminal seeking to fraudulently activate a card 100 may attempt to do so through creating a fraudulent single digital image 110. One method of creating a fraudulent digital image would be to take a picture of face 114 of account holder 112 and separately cut and paste an image of card 100 with visual identifier 108 into that photograph to create single digital image 110. For example, the criminal may intercept card 100 in the mail and then take a photograph of account holder 112 at their place of residence or business. The criminal would then attempt to combine the photograph of account holder 112 with card 100 and send it to transaction computer system in an attempt to defraud the account holder and the financial institution. Selfie-image security module 124 analyzes single digital image 110 for any and all markers that indicate that single digital image 110 has in anyway been digitally altered.

If selfie-image security module 124 determines that single digital image 110 has been digitally altered, single digital image 110 is rejected and the account 102 of card 100 is placed on a fraud freeze to prevent further activity. Selfie-image security module 124 then sends a message to communications module 122 that the single digital image 124 has been rejected. Communications module 122 then sends a communication to account holder 112 of the fraud attempt.

If selfie-image security module 124 determines that single digital image 110 has not been digitally altered, selfie-image security module 124 passes single digital image onto selfie-cryptographic key generator module 126. Selfie-cryptographic key generator module 126 produces a selfie-cryptographic key 126 from single digital image 110. This selfie-cryptographic key is utilized to encrypt account information of account holder 112 in database 128. Database 128 is a non-volatile storage system that may include solid-state storage, magnetic disc or tape storage, or optical storage. Once the account information of account holder 112 is encrypted with the selfie-cryptographic key, both single digital image 110 and the selfie-cryptographic key are discarded. Card 100 is then activated and transaction computer system 120 send a message back to registered device 116 with communications module 122 that card 100 is activated.

Discarding this image enhances the security of database 128. If any hacker attempts to hack database 128, they will only access encrypted information. The hacker will not be able to decode the information because transaction computer system 120 does not have the selfie-cryptographic key. The selfie-cryptographic key is created for a transitory period of time when account holder 112 sends a single digital image 110 that includes both his face 114 and visual identifier 108. Eliminating permanent storage of selfie-cryptographic key from transaction computer system 120 enhances the security of database 128.

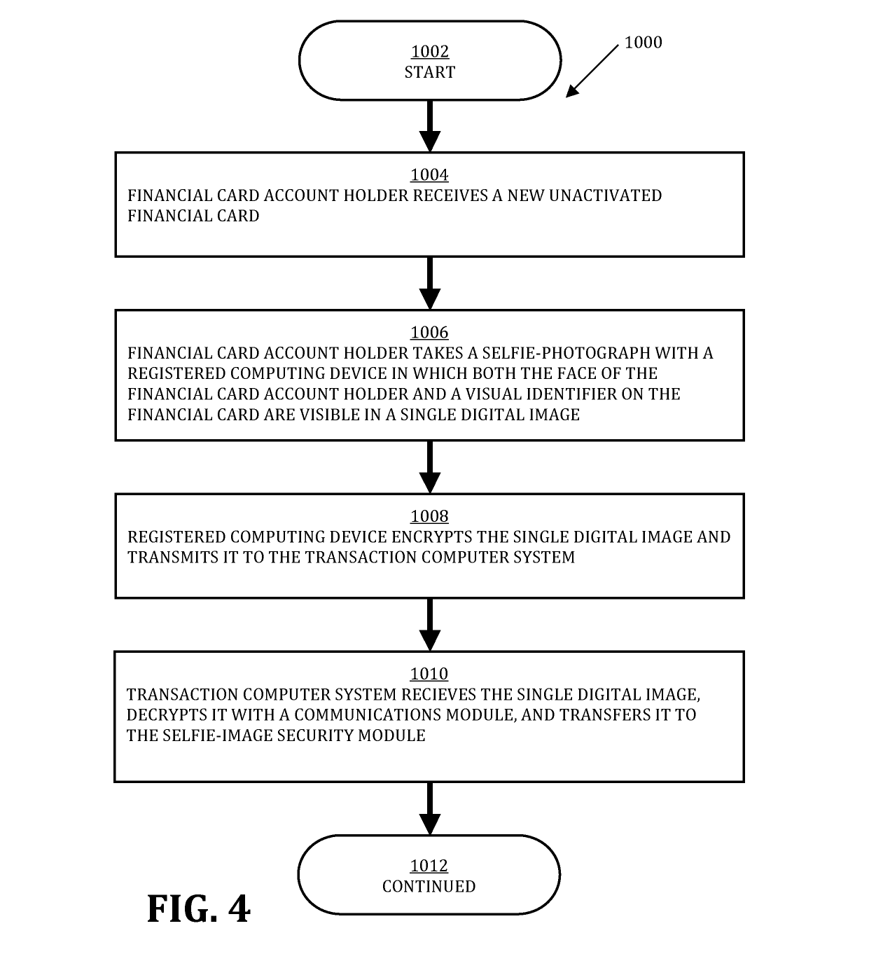

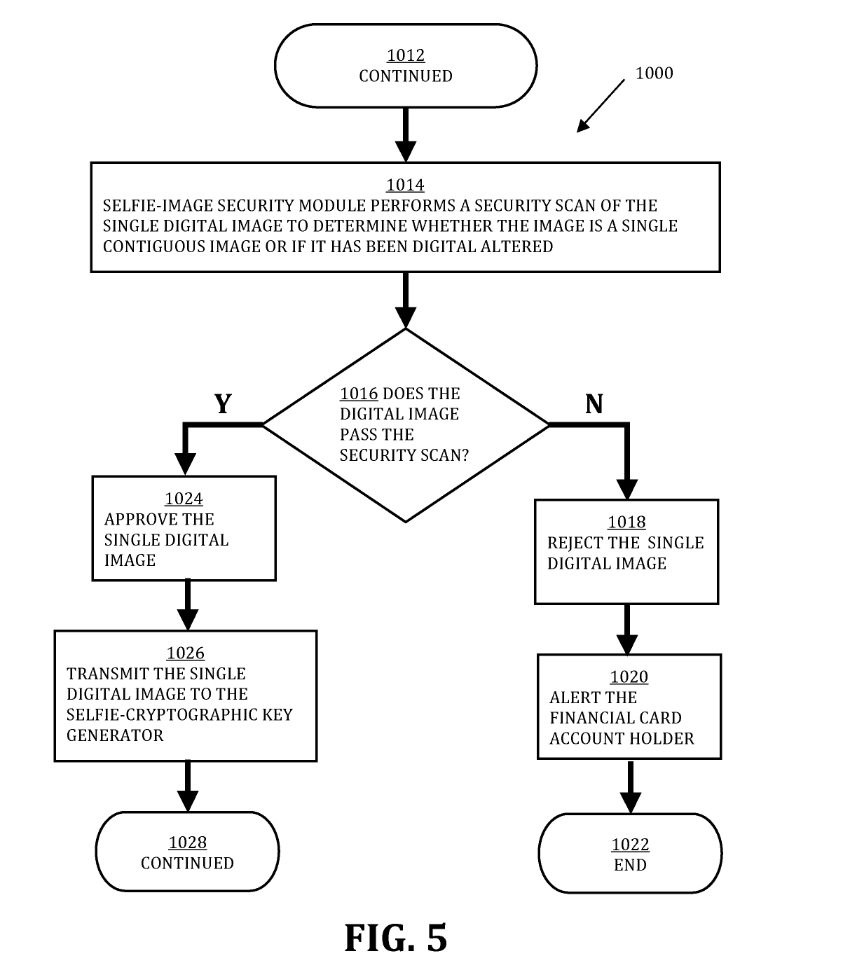

FIGS. 4-8 depict a process where a financial card account holder 112 activates a financial card 100 for use. FIG. 4 illustrates a flow chart 1000 depicting a process whereby a financial card account holder 112 takes a single digital image 110 of both the account holder's face 114 and the visual identifier 108 on the financial card 100 with an authorized device 116 and transmits it to the transaction computer system 120. The process begins with START 1002. In step 1004, financial card account holder 112 receives a new unactivated card 100, typically through conventional mail through the United States Postal Service (USPS). In order to activate card 100, in step 106 financial card account holder 112 takes a selfie-photograph with a registered computing device 116, such as a cell phone in which both the face 114 of financial card account holder 112 and visual identifier 108 on card 100 are visible in a single digital image 110. In step 1008, registered computing device 116 encrypts single digital image 110 and transmits it to transaction computer system 120 through global computing network 118 via a digital message. In step 1010, transaction computer system 120 receives single digital image 110. Communications module 122 decrypts single digital image 110 and transfers it to selfie-image security module 124. The process continues in step 1012 to FIG. 5.

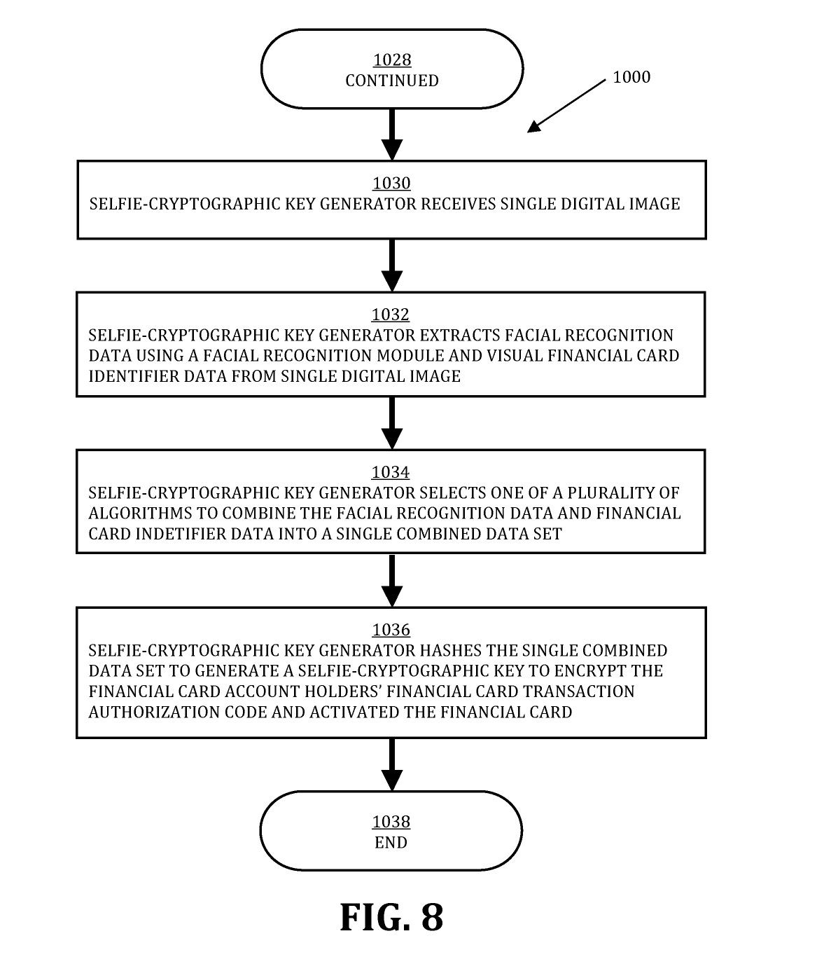

FIG. 5 illustrates a flow chart 1000 depicting a process whereby a selfie-image security module 124 performs a security scan on the single digital image 110. The process continues in step 1012. In step 1014, selfie-image security module 124 performs a security scan of single digital image 110 to determine whether it is a single contiguous image or whether it has been digitally altered in any form. Digital alteration of single digital image 110 is a clear indication that single digital image is fraudulent. In step 1016, selfie-image security module 124 determines whether single digital image 110 passes the security scan. If single digital image 110 does not pass the security scan, selfie-image security module 124 rejects single digital image in step 1018. Subsequently in step 1020, financial card account holder 112 is alerted to the fraud warning and the process ENDS in step 1022. If selfie-image security module 124 determines that single digital image 110 has not been digitally altered, selfie-image security module 124 approves single digital image in step 1024. Subsequently in step 1026, single digital image 110 is transmitted to selfie-cryptographic key generator 126. The process continues then in step 1028 in FIG. 8.

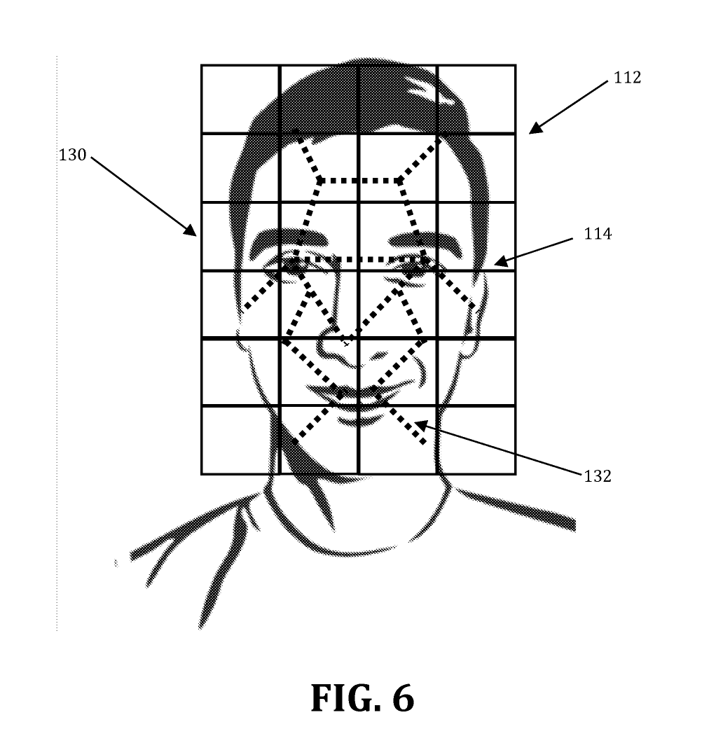

FIG. 6 illustrates a portion of the single digital image 110 showing the facial recognition features 132 of the financial card account holder 112. Facial recognition module 121 is utilized to extract digital facial recognition information from the face of a person in data of a digital picture. Selfie-cryptographic key generator 126 generates selfie-cryptographic key from single digital image 110 from two sources of information: facial recognition features 132 of account holder 112 and digital information extracted from visual identifier 108. In FIG. 6, selfie-cryptographic key generator 126 will extract facial recognition features 132 from the face 114 of account holder 112 utilizing facial recognition module 121. A grid 130 may be digitally placed over face 114 in order to extract facial recognition features 132. Some facial recognition algorithms identify facial features by extracting landmarks, or features, from an image of the subject's face 114. For example, an algorithm may analyze the relative position, size, and/or shape of the eyes, nose, cheekbones, and jaw. These features are then used to search for other images with matching features. Other algorithms normalize a gallery of face images and then compress the face data, only saving the data in the image that is useful for face recognition. A probe image is then compared with the face data. One of the earliest successful systems is based on template matching techniques applied to a set of salient facial features, providing a sort of compressed face representation. Recognition algorithms can be divided into two main approaches, geometric, which looks at distinguishing features, or photometric, which is a statistical approach that distills an image into values and compares the values with templates to eliminate variances. Popular recognition algorithms include Principal Component Analysis using eigenfaces, Linear Discriminate Analysis, Elastic Bunch Graph Matching using the Fisherface algorithm, the Hidden Markov model, the Multilinear Subspace Learning using tensor representation, and the neuronal motivated dynamic link matching.

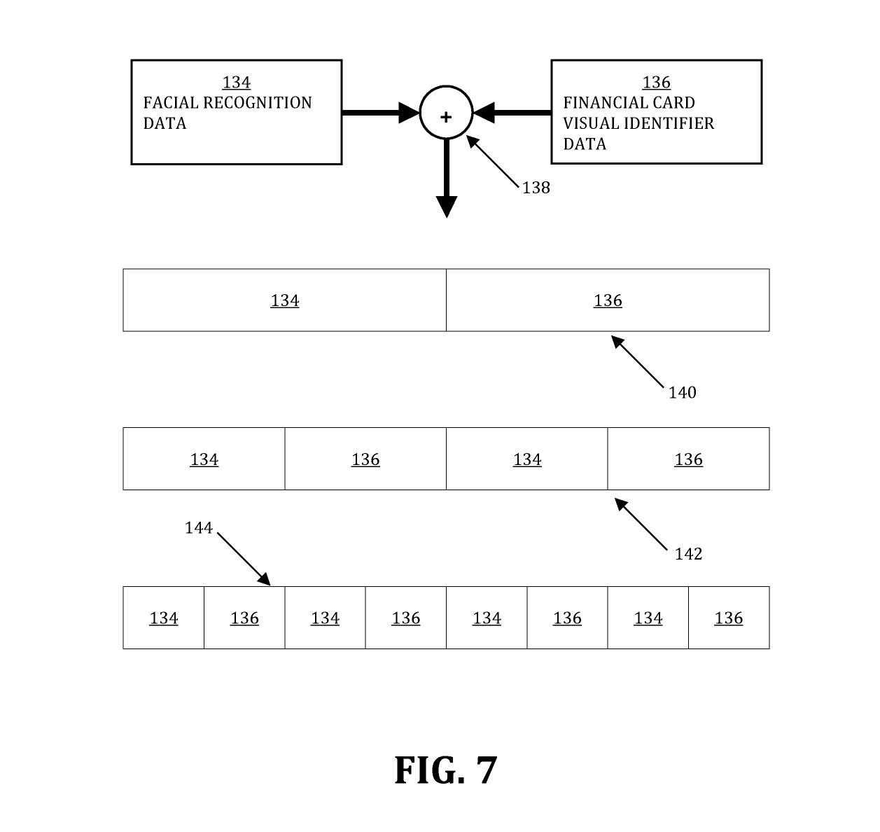

FIG. 7 depicts the operation of the selfie-cryptography key generator 126 as it combines facial recognition data 134 and financial card visual identifier data 136 into a combined single set of data 140, 142 or 144 with various algorithms. Summation unit 138 combines facial recognition data 134 and financial card visual identifier data 136 into a combined single set of data 140, 142 or 144. One algorithm may combine facial recognition data 134 and financial card visual identifier data 136 into a combined single set of data 140 by simply appending data 136 after data 134. Another algorithm my divide each data set 134 and 136 into two halves and then interleave the two halves to form combined data set 142. A further algorithm may further divide each data set 134 and 136 into smaller data units and then interleave these smaller data units to form combined data set 144. These algorithms for combine data 134 and 136 are merely exemplary. For example, the two data sets may be combined by alternating data bits into a contiguous combined single data set. Any algorithm to combine data sets 134 and 136 together into a single combined data set may be used.

FIG. 8 illustrates a flow chart 1000 depicting a process for generating a selfie-cryptographic key from the single image 110 and using it to encrypt a financial card transaction authorization code. The process continues in step 1028 from FIG. 5. In step 1030, selfie-cryptographic key generator 126 receives single digital image 110. In step 1032, selfie-cryptographic key generator extracts facial recognition data 132 and visual financial card identifier data 136 from single digital image 110. In step 1034, selfie-cryptographic key generator 126 then selects one of a plurality of algorithms discussed with respect to FIG. 7 to combine the facial recognition data 134 with the visual financial card identifier data 136 into a single combined data set. Then in step 1036, selfie-cryptographic key generator uses the single combined data set 140, 142 or 144 to generate the selfie-cryptographic key. Transaction computer system 120 then takes the selfie-cryptographic key and uses it to encrypt the financial account information of account holder 112 in database 128. During this process 1000, single digital image 110 has been temporarily stored for a transitory period of time. At this point in step 1036, single digital image 110 is deleted from all memory or non-volatile storage within transaction computer system 120. After step 1036, transaction computer system 120 does not store single digital image 110 anywhere. In step 1036, card 100 is activated and account holder 112 is notified. The process ENDS in step 1038.

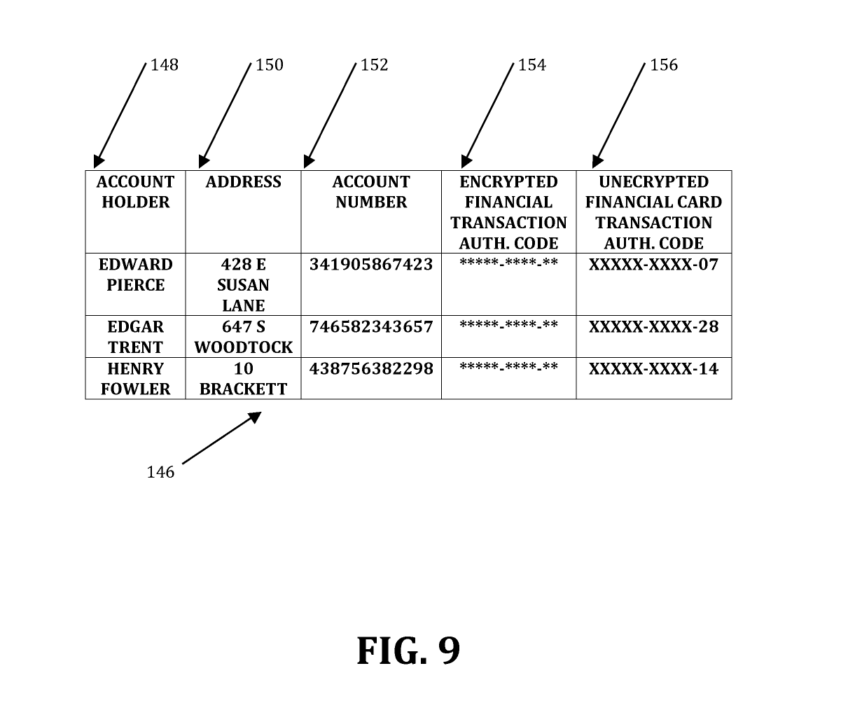

FIG. 9 depicts a database table 146 stored in database 128 containing information of the financial card account holder 148, 150, 152, 154 and 156 including the encrypted 154 and unencrypted 156 financial card transaction authorization codes. Database 128 stores table 146. Table 146 includes account information relevant to the financial account 102 of account holder 106/112. Table 146 includes an exemplary listing of such account information such as address 150, and account number 152, and account holder's name 148. Transaction computer system 120 uses selfie-cryptographic key to encrypt a financial card transaction authorization code 154. Transaction computer system 120 keeps a record of the unencrypted financial card transaction authorization code 156. New selfie-cryptographic keys, also referred to as transaction-cryptographic keys, are created from new single digital images 110 to unencrypt encrypted codes 154 as a part of a financial transaction. If the unencrypted encrypted code 154 matches unencrypted code 156, then transactions are allowed to proceed. A transaction-cryptographic key is a selfie-cryptographic key in that it is generated from a selfie picture 110 of a person in possession of card 100. However, transaction-cryptographic key is different, for purposes of reference, from selfie-cryptographic key to distinguish the key used in the card activation process from the key used in the card transaction process.

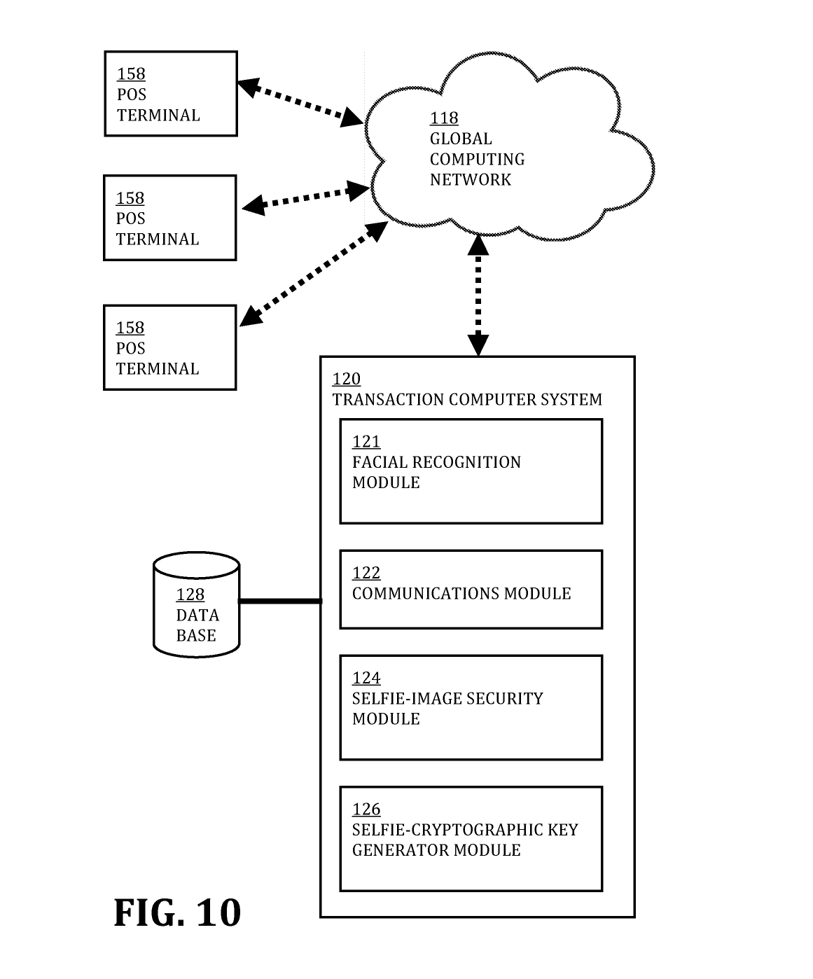

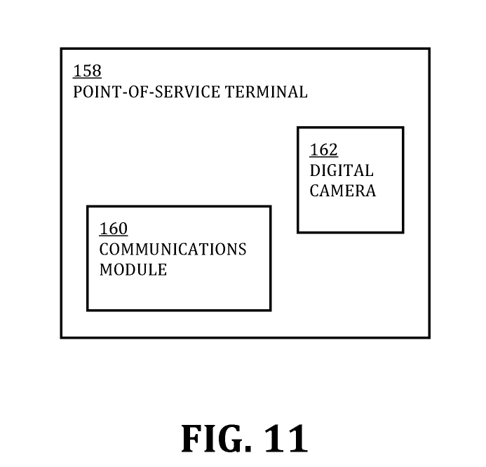

FIG. 10 illustrates a block diagram of several POS terminals 158 coupled to a transaction computer system 120 through a global computer network 118. Once account holder 112 has activated his card 100, he will use it in commerce. In today's economy, many financial card transactions occur through card swipes in which the card account holder swipes the magnetic stripe of the card through a magnetic stripe reader. The magnetic stripe reader takes information about the account and account holder off of the magnetic stripe in order to process the transaction. In the present system, no card swipe with a magnetic stripe reader is employed. In the present system, all Point-Of-Service (POS) Terminals 158 are equipped with digital cameras 162 (shown in FIG. 11). When making a purchase, account holder 112 will pull out his card 100 and hold it up to his face 114 so that digital camera 162 of POS terminal 158 can take a single digital image 110 containing both face 114 of account holder 112 and visual identifier 108 of card 100. POS terminal 158 encrypts this single digital image 110 and transmits it to transaction computer system 120 through global computing network 118. POS terminal 158 and transaction computer system 120 are in bidirectional communications with each other through global computing network 118.

Communications module 122 receives encrypted single digital image 110 and decrypts it. Communications module 122 then transfers single digital image 110 to selfie-image security module 124. Selfie-image security module 124 examines single digital image 110 for any evidence of digital tampering. If single digital image 110 has been tampered with, image 110 is rejected, the transaction is regarded as fraudulent, and the transaction is subsequently blocked. If single digital image 110 is not found to be tampered with, it is transferred on to selfie-cryptographic key generator 126. Selfie-cryptographic key generator 126 extracts facial recognition data 134 and card visual identifier data 136 from single digital image 110 to create a single combined data set that is used to generate a second selfie-cryptographic key through a hash or other method that is the same method used to create the original key used to encrypt database 128 in the card activation process. The second selfie-cryptographic key, also referred to as a transaction-cryptographic key, is used to unencrypt the encrypted financial authorization code 154. If this unencrypted version of the encrypted authorization code 154 matches the unencrypted authorization code 156, the transaction has been authenticated. The transaction has been authenticated because the data to create the second selfie-cryptographic key is the same data used to create the original selfie-cryptographic key used to encrypt the authorization code 154 in the first place, i.e. the facial recognition features 132 are the same and the card visual identifier 108 is the same. In other words, the single digital image 110 transmitted by the POS terminal shows that the account holder 112 is in possession of the financial card 100 and that the account holder 112 is the same person who activated card 100. This authentication enhances the security of the financial transaction. When the transaction has been authenticated, transaction computer system 120 sends an approved message to POS terminal 158 to complete the transaction. If the person in single digital image 110 is not the account holder, then the transaction-cryptographic key will be different from the original selfie-cryptographic key. Thus, the transaction-cryptographic key will not unencrypt the encrypted financial authorization code. In such an event, the transaction system will transmit an authorization rejection code denying the transaction.

FIG. 11 illustrates a block diagram of a POS terminal 158 including a digital camera 162 and a communications module 160. Digital camera 162 takes single digital image 110 containing both visual identifier 108 of card 100 and facial recognition features 132 of account holder 112 when account holder seeks to pay for an item through POS terminal 158. The taking of this single digital image 110 is analogous to a card swipe of a magnetic strip with current credit or debit cards. Communications module 160 encrypts this single digital image 110 and transmits it to transaction computer system 120 through global computer network 118 for authentication. Communications modules 160 subsequently receives the approved or rejected messages from transaction computer system 120 depending on whether the authentication with single digital image 110 was successful.

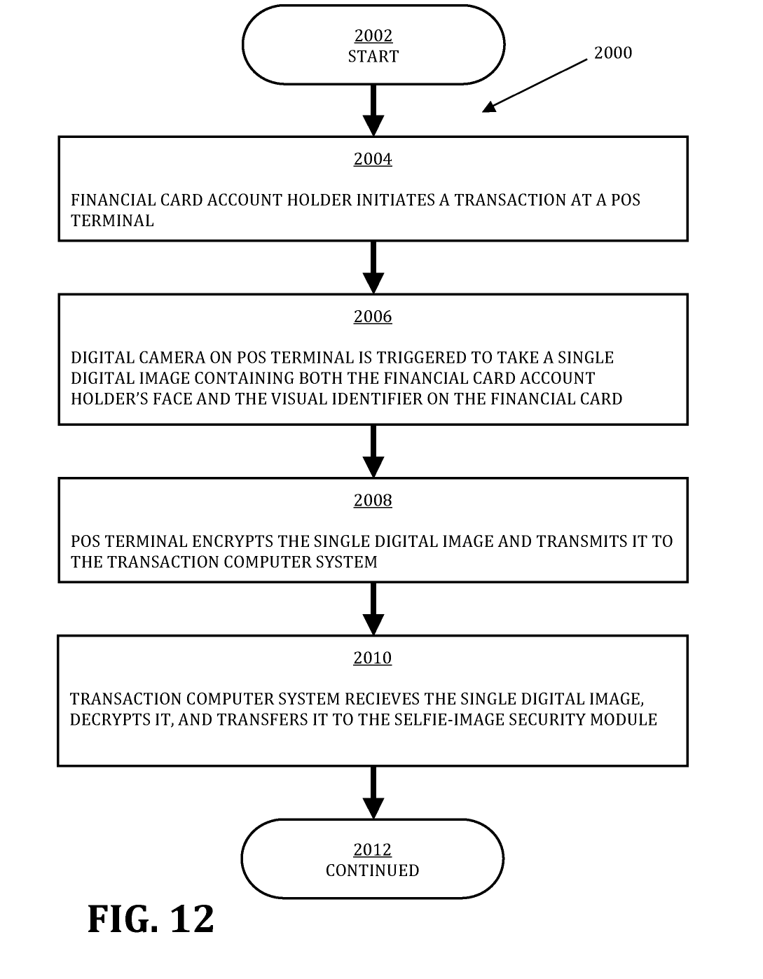

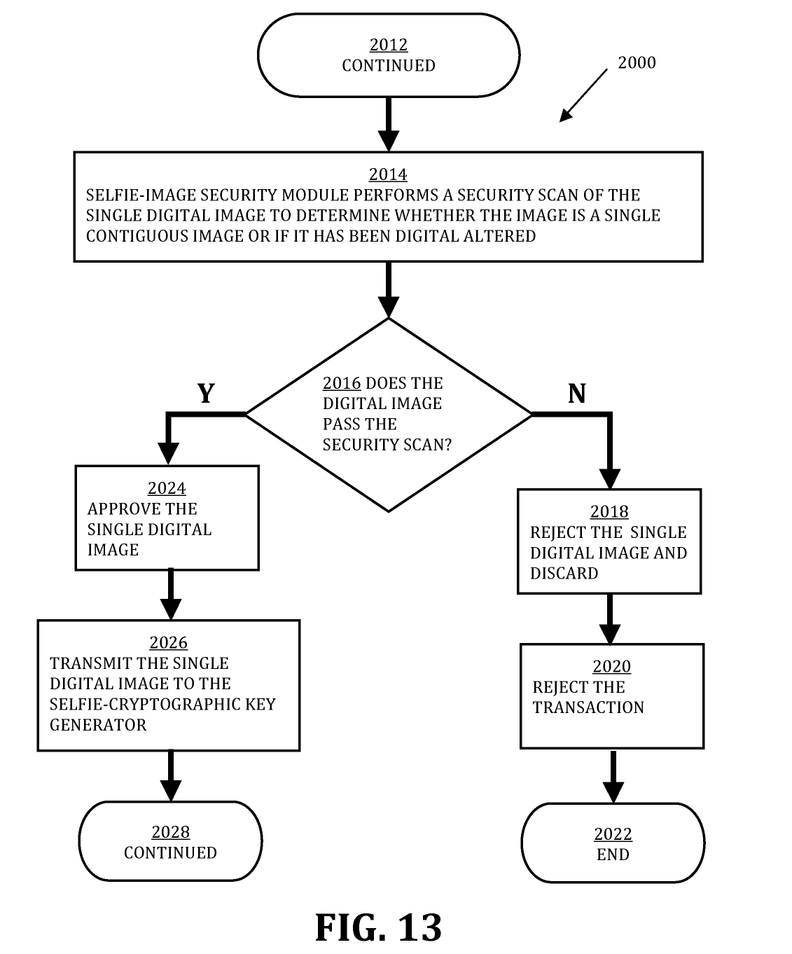

FIG. 12-15 illustrates a process whereby a financial card possessor 112 makes a transaction at a POS terminal 158 with a financial transaction card 100. FIG. 12 illustrates a flowchart 2000 depicting a process whereby a POS terminal 158 takes a single digital image 110 containing both facial recognition data 132 of a financial card possessor 112 and a visual identifier 108 of a financial transaction card 100 with camera 162. The process begins with START 2002. In step 2004, financial card possessor 112, who may or may not be the actual financial account holder 112, initiates a transaction at a POS terminal 158 to make a purchase. In step 2006, a digital camera 162 on POS terminal 158 is triggered to take a single digital image 110 of both face 114 of financial card possessor 112 and visual identifier 108 of card 100 as shown in FIG. 2. In step 2008, POS terminal 158 encrypts the single digital image 110 and transmits it to the transaction computer system 120 through global computer network 118 for authentication to authorize the transaction. In step 2010, transaction computer system 120 receives single digital image 110 and decrypts it with communications module 122. Once digital image 110 is decrypted, it is transferred to selfie-image security module 124. The process continues in step 2012 in FIG. 13.

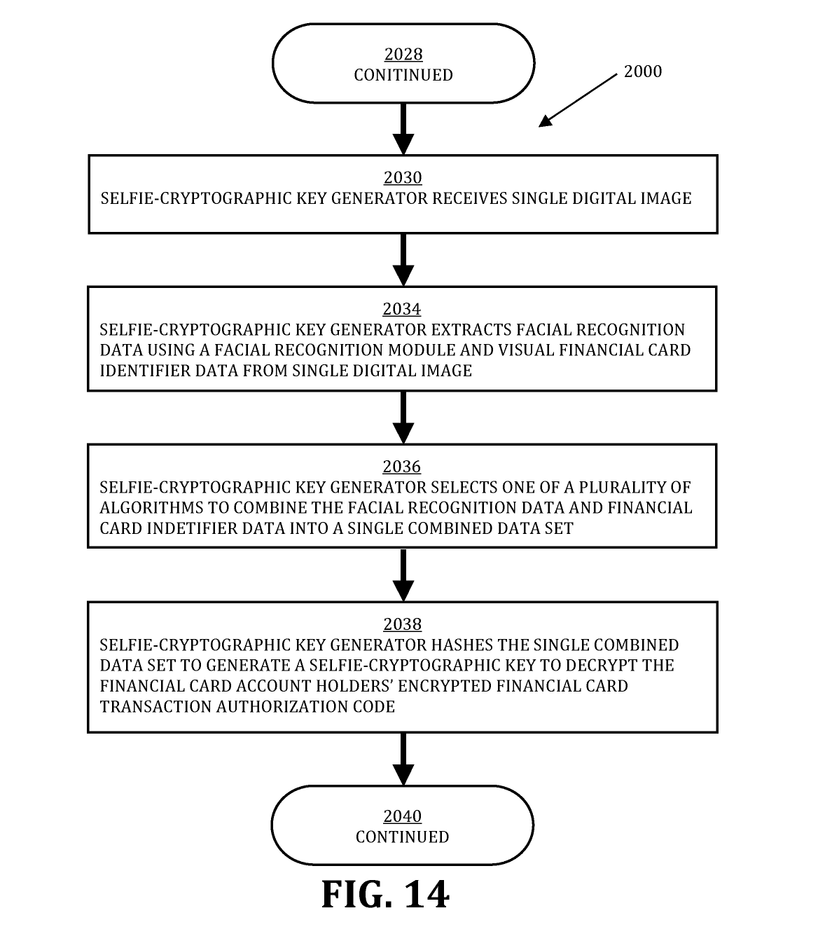

FIG. 13 illustrates a flowchart 2000 depicting a process whereby selfie-image security module 124 performs a security scan of the single digital image 110. In step 2014, selfie-image security module 124 performs a security scan of single digital image 110 to determine whether the image is a single contiguous image or whether it has been digitally altered. Any digital alteration of image 110 is an indication that single digital image 110 has been tampered with and is therefore the subject of a fraudulent transaction. In step 2016, if the digital image 110 has been altered and fails the security scan, in step 2018 the single digital image 110 is rejected. Subsequently in step 2020, the transaction is rejected and a rejection message is transmitted back to POS terminal 158 by communications module 122. The process then ENDS with step 2022. If digital image 110 passes the security scan in step 2016, single digital image 2024 is approved in step 2024. Then in step 2026, single digital image 110 is transmitted to the selfie-cryptographic key generator 124. The process continues in step 2028 in FIG. 14.

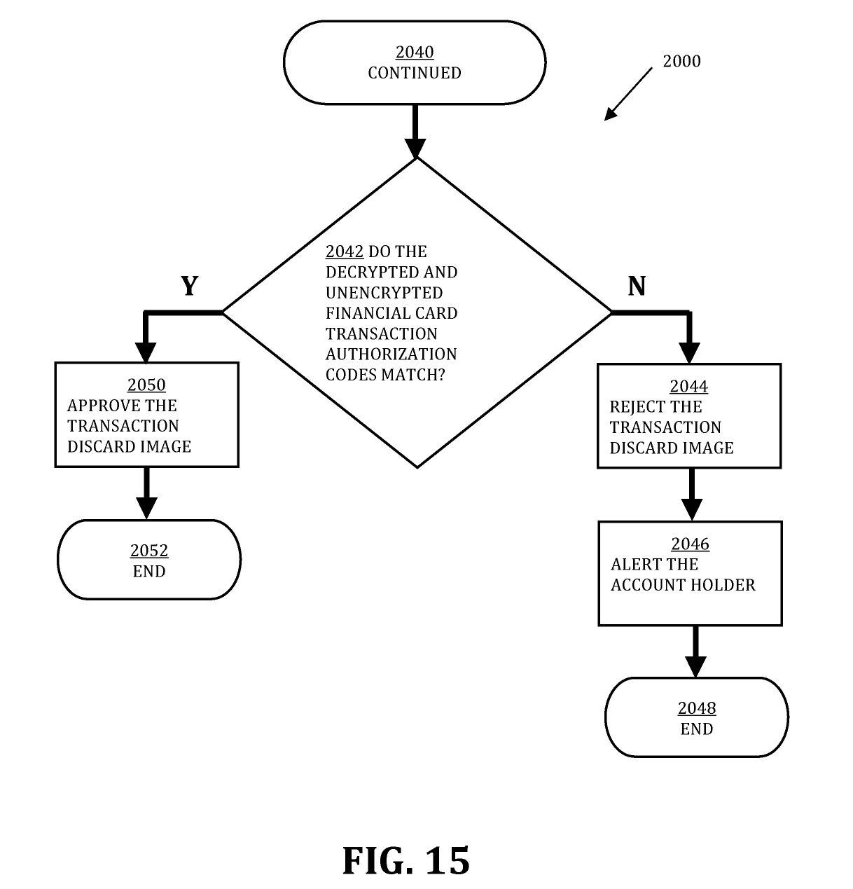

FIG. 14 illustrates a flowchart 2000 depicting a process where a selfie-cryptographic key generator 124 creates a transaction-cryptographic key by extracting facial recognition data 132 and other data from the visual identifier 108 of the financial transaction card 100. Continuing the process in step 2028, in step 2030, selfie-cryptographic key generator receives single digital image 110. In step 2034, selfie-cryptographic key generator extracts facial recognition data 134 and visual financial card identifier data 136 from single digital image 108. In step 2036, selfie-cryptographic key generator selects one of a plurality of algorithms to combine the facial recognition data 134 with the card visual identifier data 136 into a combined single data set 140, 142 or 144. Then in step 2038, selfie-cryptographic key generator creates a transaction-cryptographic key. This selfie-cryptographic key is used to decrypt the authorization code 154 associated with financial card 100. The process continues in step 2040 in FIG. 15.

FIG. 15 illustrates a flowchart 2000 depicting a process where the decrypted 154 and unencrypted 156 financial card transaction authorization codes are compared to determine whether to authorize the transaction. In step 2042, if this decrypted code 154 does not match the unencrypted code 156, it shows that the facial recognition data 134 or card visual identifier data 136 does not match the original data. This difference in facial recognition data 134 is an indication that the person 112 in possession of the card 100 making the transaction is not the true financial card account holder 112 and the transaction is rejected in step 2044. As such, the transaction is fraudulent and transaction system 120 sends a rejected message to POS terminal 158 and the account holder 112 in step 2046. The process then ENDS in step 2048. In step 2042, if this decrypted code 154 matches the unencrypted code 156, the transaction is approved in step 2050 and an approved message is sent by communications module 122 to POS terminal 158. When the decrypted code 154 matches the unencrypted code 156, it is proof that the facial recognition features of the person making the transaction purchase are the same as the account holder 112, strongly indicating that it is the same person. This then shows that the account holder 112 is then in possession of card 100 and is making the purchase, thereby securely establishing the propriety of the transaction. The process then ENDS in step 2052.

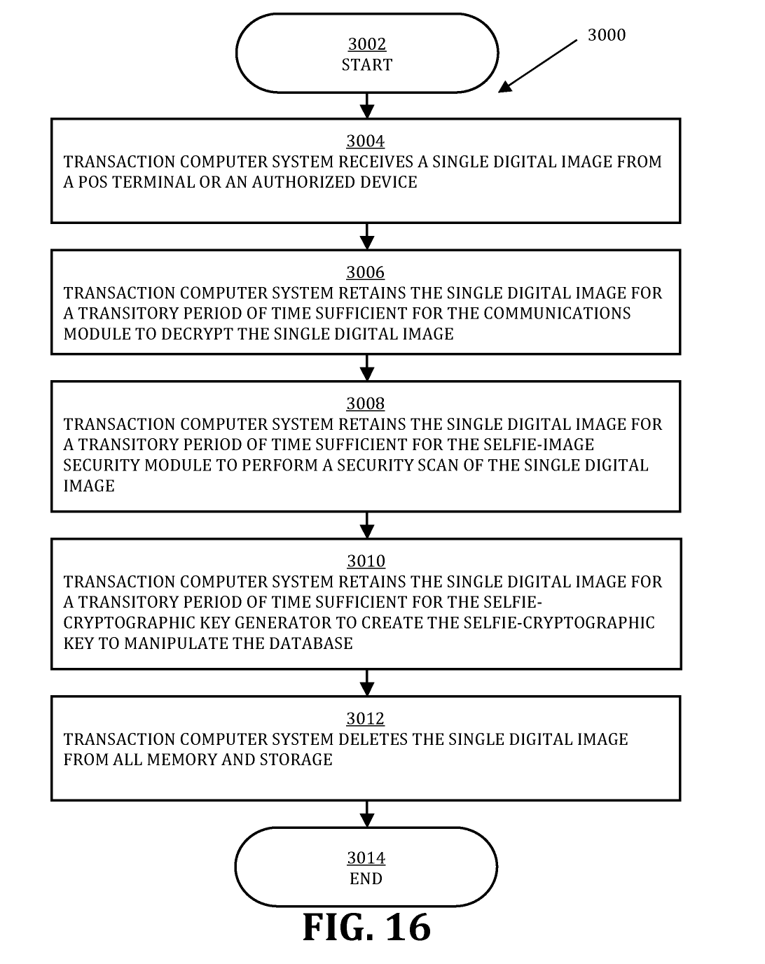

FIG. 16 illustrates a flow chart 3000 depicting a process for retention of the single digital image 110 by the transaction computer system 120. The process begins with START 3002. In step 3004, transaction computer system 120 receives single digital image 110 from a POS terminal 158 or an authorized device 116. In step 3006, transaction computer system 120 retains single digital image 110 for a transitory period of time sufficient for communications module 122 to decrypt single digital image 110. In step 3008, transaction computer system 120 retains single digital image 110 for a transitory period of time sufficient for selfie-image security module 124 to perform a security scan of single digital image 110. In step 3010, transaction computer system 120 retains single digital image 110 for a transitory period of time sufficient for the selfie-cryptographic key generator 124 to create the selfie-cryptographic key to manipulate database 128. In step 3012, transaction computer system deletes single digital image 110 from all memory in storage. By deleting the single digital image 110 from all memory and storage, hackers cannot gain access to digital image 110 and create selfie-cryptographic key themselves to hack the account 102 of account holder 112 except for that transitory period of time that it is within transaction computer system 120. Transaction computer system 120 may handle accounts for millions, perhaps hundreds of millions of accounts. Hacking system 120 at any given time will only give access to a small population of single images 110 from which hackers could attempt to recreate selfie-cryptographic keys and hack the accounts. Since all digital images 110 are discarded by system 120 after use, the vast majority of digital images will not be present in system 120 when it is hacked.

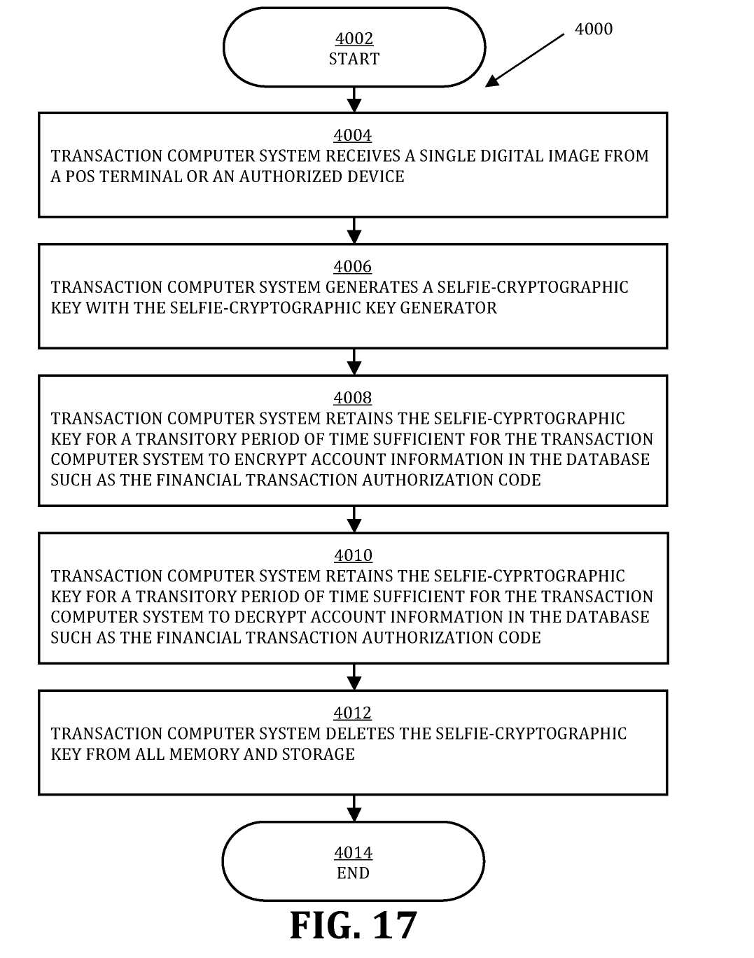

FIG. 17 illustrates a flow chart 4000 depicting a process for retention of the single digital image 110 by the transaction computer system 120. The process begins with START 4002. In step 4004, transaction computer system 120 receives single digital image 110 from a POS terminal 158 or an authorized device 116. In step 4006, selfie-cryptographic key generator 124 creates the selfie-cryptographic key to manipulate database 128. In steps 4008 and 4010, transaction computer system 120 retains the selfie-cryptographic key for a transitory period of time sufficient for the transaction computer system 120 to encrypt or decrypt account information stored in database 128 such as the authorization code 154. In step 4012, transaction computer system 120 deletes the selfie-cryptographic key from all memory and storage. The process ENDS in step 4014. By deleting the selfie-cryptographic key from all memory and storage, hackers cannot gain access to the selfie-cryptographic key to hack the account 102 of account holder 112 except for that transitory period of time that it is within transaction computer system 120. Transaction computer system 120 may handle accounts for millions, perhaps hundreds of millions of accounts. Hacking system 120 at any given time will only give access to a small population of selfie-cryptographic keys from which hackers could hack the accounts. Since all selfie-cryptographic keys are created on an as needed transitory basis by system 120 and discarded after use, the vast majority of selfie-cryptographic keys will not be present in system 120 when it is hacked.

A financial card authorization system for a transaction includes a database 128 containing encrypted account information 146 for a financial card account holder 112 encrypted with a selfie-cryptographic key. The selfie-cryptographic key is generated utilizing first data 140, 142, or 144 contained within a first single image 110. The first data 140, 142, or 144 includes both facial recognition features 132 of the financial card account holder 112 and a visual card identifier 108 on a financial card 100 associated with the account information 146. The system also includes a cryptographic key generator 126 that generates a transaction-cryptographic key utilizing second data 140, 142 or 144 contained within a second single image 110. The second data 140, 142, or 144 includes both the visual financial card identifier 108 on the financial card 100 and facial recognition features 132 of a person 112 in possession of the financial card 100. Additionally, the system also includes a transaction system 120 that applies the transaction-cryptographic key to the encrypted account information 146 stored in the database 128. The transaction system 120 transmits a transaction authorization code when the transaction-cryptographic key successfully decrypts the encrypted account information 146. The financial card authorization system does not permanently store the transaction-cryptographic key in memory, but retains it for a transitory period during an authorization of a financial card transaction. The cryptographic key generator 126 generates the selfie-cryptographic key. The financial card authorization system does not permanently store the selfie-cryptographic key but retains it for a transitory period during encryption of the account information in the database 128. The first single image 110 is a first digital picture of the financial card 100 placed next to the financial card account holder's face 114. The second single image 110 is a second digital picture of the financial card placed 100 next to the face 114 of the person in possession of the financial card 100. The cryptographic key generator 126 utilizes a facial recognition module to extract facial recognition features from the first digital picture of the financial card account holder's face. The cryptographic key generator utilizes the facial recognition module 121 to extract facial recognition features 132 from the second digital picture 110 of the face 114 of the person in possession of the financial card 100. The visual financial card identifier 108 is information printed on the financial card 100. The information printed on the financial card is a QR code, a bar code, or a hologram. The encrypted account information 146 for the financial card account holder 112 is initially encrypted with an initial-cryptographic key before it is encrypted with the selfie-cryptographic key. The initial-cryptographic key is generated without any facial recognition features 132 of the financial card account holder 112. The encrypted account information 146 for the financial card account holder 112 is then re-encrypted with the selfie-cryptographic key during a financial card activation process 1000 in which the financial card account holder 112 creates the first single image 110 utilizing an authorized device 116 that digitally transmits the first single image 110 to the cryptographic key generator 126 across a communications network 118. The authorized device 116 is a mobile electronic device previously associated with the account information 146. The authorized device 116 may also be a non-mobile wired electronic device previously associated with the account information 146.

The financial card authorization system may also include an image analysis security system 124. The cryptographic key generator 126 generates the selfie-cryptographic key from the first single image 110 only when it is authorized by the image analysis security module 124 when the image analysis security module 124 determines that the first single image 110 has not been tampered with. The cryptographic key generator 126 generates the transaction-cryptographic key from the second single image 110 only when it is authorized by the image analysis security module 124 when the image analysis security module 124 determines that the second single image 110 has not been tampered with. The transaction system 120 transmits a transaction rejection code when the image analysis security module 124 determines that the second single image 110 has been tampered with. The transaction system 120 transmits a transaction rejection code when the transaction-cryptographic key unsuccessfully decrypts the encrypted account information 146. The cryptographic key generator 126 receives the second single image 110 via a digital message sent over a communications network 118 from a point-of-service terminal 158 equipped with a digital camera 162. The digital camera 162 captured the single second image 110. The financial card authorization system does not permanently store the first single image 110 but retains it for a transitory period during encryption of the account information 146 in the database 128. The financial card authorization system does not permanently store the second single image 110 but retains it for a transitory period during the transaction.

While the invention has been shown and described with reference to a particular embodiment thereof, it will be understood to those skilled in the art, that various changes in form and details may be made therein without departing from the spirit and scope of the invention.

1. A financial card authorization system for a transaction, comprising:
a database containing encrypted account information for a financial card account holder encrypted with a selfie-cryptographic key, the selfie-cryptographic key being generated utilizing first data contained within a first single image, the first data including both facial recognition features of the financial card account holder and a visual card identifier on a financial card associated with the encrypted account information;
a cryptographic key generator that generates a transaction-cryptographic key utilizing second data contained within a second single image, the second data including both the visual financial card identifier on the financial card and facial recognition features of a person in possession of the financial card; and
a transaction system that applies the transaction-cryptographic key to the encrypted account information stored in the database, the transaction system transmits a transaction authorization code when the transaction-cryptographic key successfully decrypts the encrypted account information, the financial card authorization system does not permanently store the transaction-cryptographic key but retains it for a transitory period during an authorization of a financial card transaction.

2. The financial card authorization system of claim 1, wherein the cryptographic key generator generates the selfie-cryptographic key, the financial card authorization system does not permanently store the selfie-cryptographic key but retains it for a transitory period during encryption of the encrypted account information in the database.

3. The financial card authorization system of claim 2, wherein the first single image is a first digital picture of the financial card placed next to the financial card account holder's face.

4. The financial card authorization system of claim 3, wherein the second single image is a second digital picture of the financial card placed next to the face of the person in possession of the financial card.

5. The financial card authorization system of claim 4, wherein the cryptographic key generator utilizes a facial recognition module to extract facial recognition features from the first digital picture of the financial card account holder's face.

6. The financial card authorization system of claim 5, wherein the cryptographic key generator utilizes the facial recognition module to extract facial recognition features from the second digital picture of the face of the person in possession of the financial card.

7. The financial card authorization system of claim 6, wherein the visual financial card identifier is information printed on the financial card.

8. The financial card authorization system of claim 7, wherein the information printed on the financial card is a QR code.

9. The financial card authorization system of claim 7, wherein the information printed on said financial card is a bar code.

10. The financial card authorization system of claim 7, wherein the information printed on said financial card is a hologram.

11. The financial card authorization system of claim 8, wherein the encrypted account information for the financial card account holder is initially encrypted with an initial-cryptographic key before it is encrypted with the selfie-cryptographic key, the initial-cryptographic key being generated without any facial recognition features of the financial card account holder.

12. The financial card authorization system of claim 9, wherein the encrypted account information for the financial card account holder is re-encrypted with the selfie-cryptographic key during a financial card activation process in which the financial card account holder creates the first single image utilizing an authorized device that digitally transmits the first single image to the cryptographic key generator across a communications network.

13. The financial card authorization system of claim 10, wherein the authorized device is a mobile electronic device previously associated with the encrypted account information.

14. The financial card authorization system of claim 10, wherein the authorized device is a non-mobile wired electronic device previously associated with the encrypted account information.

15. The financial card authorization system of claim 1, further comprising an image analysis security module, wherein the cryptographic key generator generates the selfie-cryptographic key from the first single image only when it is authorized by the image analysis security module when the image analysis security module determines that the first single image has not been tampered with, wherein the cryptographic key generator generates the transaction-cryptographic key from the second single image only when it is authorized by the image analysis security module when the image analysis security module determines that the second single image has not been tampered with.

16. The financial card authorization system of claim 1, wherein the transaction system transmits a transaction rejection code when the image analysis security module determines that the second single image has been tampered with.

17. The financial card authorization system of claim 1, wherein the transaction system transmits a transaction rejection code when the transaction-cryptographic key unsuccessfully decrypts the encrypted account information.

18. The financial card authorization system of claim 1, wherein the cryptographic key generator receives the second single image via a digital message sent over a communications network from a point-of-service terminal equipped with a digital camera, wherein the digital camera captured the single second image.

19. The financial card authorization system of claim 1, wherein the financial card authorization system does not permanently store the first single image but retains it for a transitory period during encryption of the encrypted account information in the database.

20. The financial card authorization system of claim 1, wherein the financial card authorization system does not permanently store the second single image but retains it for a transitory period during the transaction.
